(19) United States
(12) Patent Application Publication
(10) Pub. No.: US 2010/0025066 A1
(43) Pub. Date: Feb. 4, 2010

(54) TWO-GANG MUD RING UNIVERSAL BASE

(75) Inventor: Ian Rubin de la Borbolla, Memphis, TN (US)

Correspondence Address: HOFFMANN & BARON, LLP, 6900 JERICHO TURNPIKE, SYOSSET, NY, 11791, US

(73) Assignee: THOMAS & BETTS INTERNATIONAL, INC., Wilmington, DE (US)

(21) Appl. No.: 12/512,189

(22) Filed: Jul. 30, 2009

Related U.S. Application Data
(60) Provisional application No. 61/085,045, filed on Jul. 31, 2008.

(51) Int. Cl. H02G 3/08

(52) U.S. Cl. 174/57

(57) ABSTRACT

This invention pertains to an adjustable cover for an electrical outlet box. The cover is configured having a generally planar mounting plate with a collar surrounding an opening. The mounting plate including various apertures to allow for mounting to various sized boxes.

### CROSS-REFERENCE TO RELATED APPLICATION

This application claims priority to U.S. Provisional Patent Application No. 61/085,045 filed on Jul. 31, 2008, all of which are incorporated herein by reference.

### FIELD OF THE INVENTION

This invention pertains to a cover of an electrical outlet box and more particularly to a mud ring mountable to different size outlet boxes.

### BACKGROUND OF THE INVENTION

During construction, electrical outlet boxes are affixed to their support or stud prior to the wall covering (i.e. dry wall) being installed. It is generally known what thickness of dry wall is going to be installed and hence electrical outlet boxes are installed off-set from the front of the stud by that amount so as to be flush with the wall. However, if the dry wall thickness is not known or if it changes or if additional wall material (i.e. tile, sound insulation, double-layer dry wall) is subsequently added, then the box opening will no longer be flush with the wall and hence it will be difficult, if not impossible, to properly install an electrical device within the box.

Additionally, the current mud ring allows for only one size box, typically standard sizes of 4 inch or 4 11/16 inch square box. There is no interchangeability between mud rings to accommodate different sized boxes. Therefore, two different sized mud rings must be available for each box size. Additionally, an installer must carry different sized mud rings to accommodate the different box sizes. The same applies to adjustable mud rings, currently each adjustable mud ring assembly must be made with two different sized mud rings to accommodate either scenario on the job site.

Hence, there is a need for a universal mud ring to accommodate all sizes of boxes.

It is thus an object of this invention to provide a base of the mud ring which is inexpensive to manufacture and yet universal for all size boxes. A further objective is to allow the end user to have the ability to install an adjustable two gang mud ring on various box sizes.

### SUMMARY OF THE INVENTION

The present invention pertains to a mud ring or mounting plate for an electrical outlet box. The mud ring includes a square-shaped plate with a center opening therethrough. The plate includes an exterior perimeter an interior raised perimeter surrounding the opening, and a planar perimeter extending between the raised perimeter and the exterior perimeter. The planar portion includes at least five apertures to accommodate attachment of the plate to the different sized boxes.

### BRIEF DESCRIPTION OF THE DRAWINGS

FIG. 1 is a top view of the box cover of the present invention.

FIG. 2 is a top perspective view of the cover of FIG. 1.

### DETAILED DESCRIPTION OF THE PREFERRED EMBODIMENT

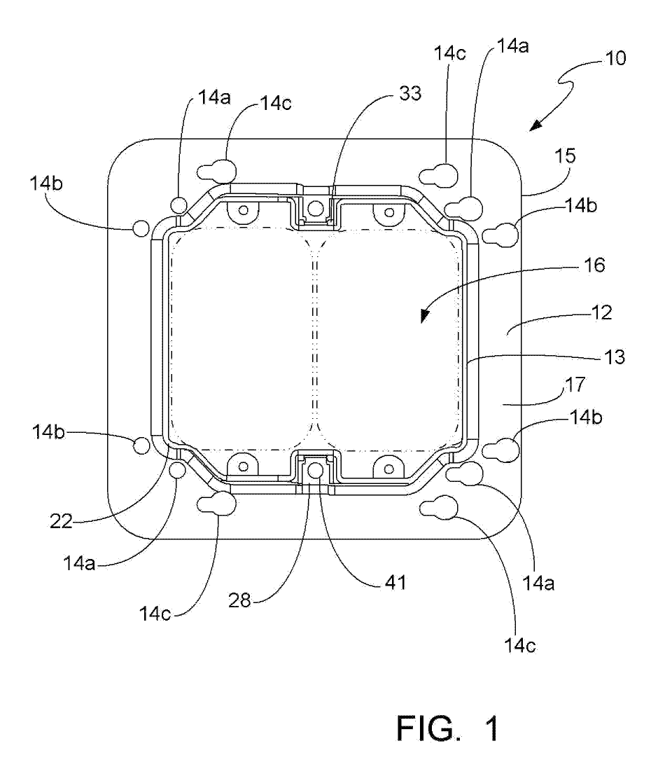

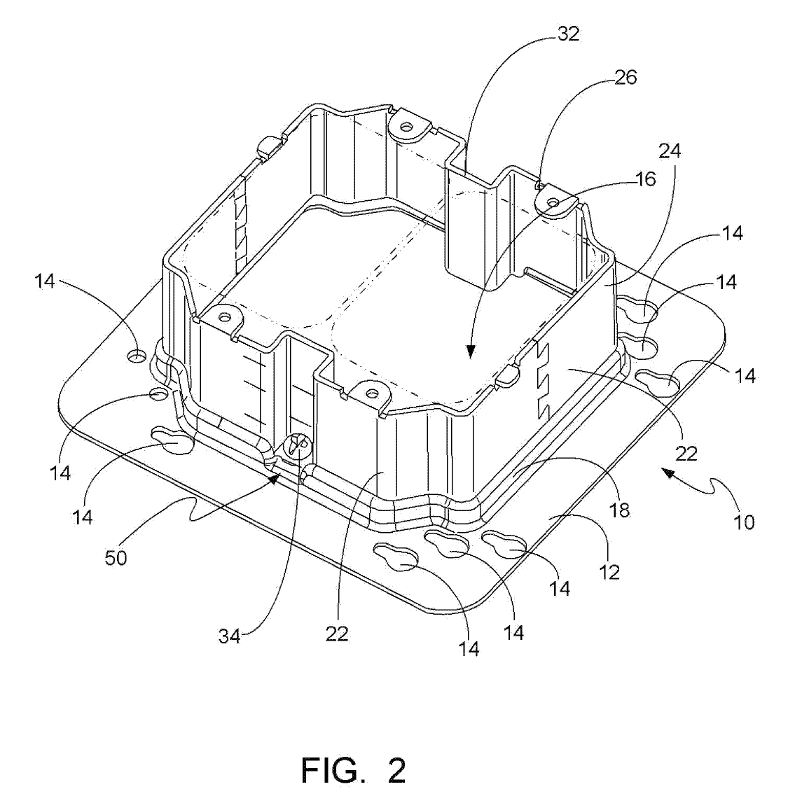

Referring to FIGS. 1-2. there is shown an adjustable device cover 10 of the present invention including a mounting plate 12, an extension sleeve 22 and a locking device 50. This assembly includes a generally rectangular base, mud ring or mounting plate 12 that is used to secure device cover 10 to an electrical outlet box (not shown) and preferably to a two or more gang box such as a 4 inch square or a 4 11/16 inch square box. A series of apertures 14 (14a, 14b and 14c) are spaced about the corners of plate 12 through which one or more fasteners would extend so as to mount cover 10 to the outlet box in the conventional fashion. These slots 14 are arranged so that mounting plate 12 can be secured to the box in a variety of different orientations, and secured to a variety of box sizes (as further described below).

The center of cover 10 contains a large opening 16 that permits access through cover 10 to the interior of the electrical outlet box. FIG. 1 shows the opening as a square opening; however other shapes are contemplated to accommodate the shape of an extension sleeve extending therethrough. Surrounding and generally defining opening 16 is collar 18 which projects away from and generally perpendicular to mounting plate 12. Collar 18 is generally rounded, being curved towards opening 16. Two opposed tabs 28 are recessed or inset from the collar 18. The collar 18 includes at least one inwardly facing tab 28. The tab 28 projects inwardly toward the opening 16. The tabs 28 include aperture 41 used for locking the extension sleeve 22 to the mounting plate 12. Tab 28 includes an interior threaded portion which mates with the exterior threading of fastener 34 to lock the fastener in place.

Extension sleeve 22 is slidably positioned within collar 18 and generally is configured with an open box-like structure having sidewalls 24 corresponding with opening 16. Extension sleeve 22 contains device mounting tabs 26 which are used to secure an electric device (not shown) to cover 10. The sidewall(s) 24 which would run adjacent to tab(s) 28 of the collar 18 include a concaved portion or a channel 32 that closely conforms to tab 28 and which protrudes into the opening 16. The tab 28 travels through the channel 32 until the preferred position is obtained after which the extension sleeve 22 is secured at position. Also, if desired, extension sleeve 22 can be configured with upper stops and/or lower stops 33 that prevent extension sleeve 22 from sliding out of mounting plate 12. Such stops can consist primarily of small projections that engage distal end of collar IS or tab 28 to retain sleeve 22 within opening 16.

FIGS. 1 and 2 show mounting plate 12 including an outer perimeter 15, an inner perimeter 13, and collar 18 surrounding the inner perimeter 13. A planar portion 17 is a planar square frame which extends between the collar 18 and the outer perimeter 15 and has various apertures 14 (14a, 14b, 14c) therethrough. The apertures 14 are located near the corners of mounting plate 12. The apertures 14 are positioned through mounting plate 12 to accommodate attachment to various sized boxes. For example, FIG. 1 shows apertures 14a including two circular holes and two oblong holes, or circular holes with a tail extending from the circular hole. One aperture 14a is located at each corner portion of the mounting plate 12. Apertures 14a are located closer to interior opening 16 as opposed to apertures 14b, because aperture 14a aligns with a 4 inch standard box attachment members. Therefore, fasteners may be placed through apertures 14a to secure the mounting plate 12 to a standard 4 inch box.

Apertures 14b and 14c also includes various size holes including circular, oblonged or circular tailed openings. Apertures 14b and 14c are located on either side of apertures 14a and closer to the outer perimeter of the mounting plate 12.

Apertures 14b and 14c align with attachment members for a 4 11/16 inch box. Apertures 14b are used for horizontal mounting of the mounting plate 12 to the box. Apertures 14c are used for vertical mounting of the mounting plate to the box.

Having described the preferred embodiments herein, it should now, be appreciated that variations may be made thereto without departing from the contemplated scope of the invention. Accordingly, the preferred embodiments described herein are deemed illustrative rather than limiting, the true scope of the invention being set forth in the claims appended hereto.

What is claimed is:

1. A mud ring for an electrical outlet box comprising:
a square shaped plate with a center opening therethrough, the plate includes an exterior perimeter, an interior raised perimeter surrounding the opening and a planar portion therebetween;
said planar portion includes a plurality apertures extending through the plate to accommodate attachment of the plate to different sized boxes.

2. The mud ring of claim 1 wherein said apertures are oblong.

3. The mud ring of claim 1 wherein each corner of said planar portion of said plate includes three apertures.

4. The mud ring of claim 3 wherein two corners are mirror images of said two other corners.

5. The mud ring of claim 4 wherein four apertures are circular and eight apertures are oblong.

6. The mud ring of claim 5 wherein said apertures are positioned to accommodate attachment to a four inch box, horizontal attachment of a four and a half inch box and vertical attachment of a four and a half inch box.

7. The mud ring of claim 6 wherein said plate includes inwardly opposed tags with threaded opening therethrough.

8. The mud ring of claim 7 wherein said raised perimeter is surrounded by a collar.

9. The mud ring of claim 1 wherein said plurality of apertures is at least five apertures.

10. A mud ring for an electrical outlet box comprising:
a square shaped plate with a center opening therethrough, the plate includes an exterior perimeter, an interior raised perimeter surrounding the opening, a rounded collar and a planar portion, said rounded collar extends from said inner raised perimeter to said planar portion, said planar portion extends from said rounded collar to said exterior perimeter;
said planar portion includes a plurality apertures extending through the plate to accommodate attachment of the plate to different sized boxes.

11. The mud ring of claim 10 further including inwardly opposed tags extending into said opening and extending from said rounded collar.

12. The mud ring of claim 11 wherein said inwardly opposed tags include a threaded opening therethrough.

13. The mud ring of claim 11 wherein said apertures are oblong.

14. The mud ring of claim 10 wherein each corner of said planar portion of said plate includes three apertures.

15. The mud ring of claim 14 wherein two corners are mirror images of said two other corners.

16. The mud ring of claim 15 wherein four apertures are circular and eight apertures are oblong.

17. The mud ring of claim 16 wherein said apertures are positioned to accommodate attachment to a four inch box, horizontal attachment of a four and a half inch box and vertical attachment of a tour and a half inch box.

18. A mud ring for an electrical outlet box comprising:
a square shaped plate with a center opening therethrough, the plate includes an exterior perimeter, an interior raised perimeter surrounding the opening, a rounded collar and a planar portion, said rounded collar extends from said inner raised perimeter to said planar portion, said planar portion extends from said rounded collar to said exterior perimeter;
said planar portion includes a plurality apertures extending through the plate to accommodate attachment of the plate to different sized boxes, said plurality of apertures are positioned in the corners of said planar portion, a pair of opposed tags extend from said collar portion towards the opening, said tags are extend between the plane of the raised inner diameter and the plane of the planar portion.

19. The mud ring of claim 18 wherein each corner of said planar portion of said plate includes three apertures.

20. The mud ring of claim 19 wherein said apertures include four apertures having a circular shape and eight apertures having an oblong shape.
